(19) United States
(12) Patent Application Publication
(10) Pub. No.: US 2022/0035914 A1
(43) Pub. Date: Feb. 3, 2022

(54) INFORMATION PROCESSING DEVICE, CONTROL METHOD, AND PROGRAM

(71) Applicant: NEC Corporation, Minato-ku, Tokyo (JP)

(72) Inventors: Kazuhiko ISOYAMA, Tokyo (JP); Yoshiaki SAKAE, Tokyo (JP); Jun NISHIOKA, Tokyo (JP); Etsuko ICHIHARA, Tokyo (JP)

(73) Assignee: NEC Corporation, Minato-ku, Tokyo (JP)

(21) Appl. No.: 17/278,767

(22) PCT Filed: Sep. 26, 2018
(86) PCT No.: PCT/JP2018/035745

§ 371 Date: Mar. 23, 2021

(51) Int. Cl. G06F 21/56

(52) U.S. Cl. CPC G06F 21/56; G06F 2221/033

(57) ABSTRACT

An information processing apparatus (2000) compares a name of a determination target file with a name of one or more normal files. The information processing apparatus (2000) outputs information related to the determination target file, when a name of the determination target file does not coincide with a name of any of the normal files, and a degree of reliability of the determination target file is equal to or less than a threshold value. A degree of reliability of the determination target file is calculated, based on a degree of similarity between a name of the determination target file and a name of each of the normal files.

### TECHNICAL FIELD

The present invention relates to a security analysis that focuses on a name of a file.

### BACKGROUND ART

A technique for performing a security analysis on, as a target, a name of a file present on a computer system has been developed. For example, PTL 1 discloses a technique for comparing a name (i.e., a name of a file accessed by a process) of a file indicated in a log that records an activity of a process with a name of a file indicated in a normal profile, and determining that an abnormality occurs when the names do not coincide with each other.

### RELATED DOCUMENT

### Patent Document

[PTL 1] Japanese Patent Application Publication No. 2010-182019

### SUMMARY OF THE INVENTION

### Technical Problem

In PTL 1, in a comparison between a name of a file indicated in a log that records an activity of a process with a name of a file indicated in a normal profile, only a determination of whether the names coincide with each other is performed. In other words, a case where names do not coincide with each other is uniformly handled in terms of a name of a file. The present invention has been made in view of the above-described problem. One of objects of the present invention is to provide a technique for improving accuracy of a security analysis that focuses on a name of a file.

### Solution to Problem

A first information processing apparatus according to the present invention includes 1) a comparison unit that compares a name of a determination target file with a name of one or more comparison target files, and 2) an output unit that outputs information related to the determination target file, when a name of the determination target file does not coincide with a name of any of the comparison target files, and a degree of reliability of the determination target file is equal to or less than a threshold value.

The comparison unit calculates a degree of reliability of the determination target file, based on a degree of similarity between a name of the determination target file and a name of each of the comparison target files.

A second information processing apparatus according to the present invention includes 1) a comparison unit that compares a name of a determination target file with a name of one or more comparison target files, and 2) an output unit that determines a display manner of information related to the determination target file, depending on whether a name of the determination target file coincides with a name of the comparison target file and according to similarity between a name of the determination target file and a name of the comparison target file, and outputs information related to the determination target file in the determined display manner.

A first control method according to the present invention is a control method being executed by a computer. The control method includes 1) a comparison step of comparing a name of a determination target file with a name of one or more comparison target files, and 2) an output step of outputting information related to the determination target file when a name of the determination target file does not coincide with a name of any of the comparison target files, and a degree of reliability of the determination target file is equal to or less than a threshold value.

In the comparison step, a degree of reliability of the determination target file is calculated, based on a degree of similarity between a name of the determination target file and a name of each of the comparison target files.

A second control method according to the present invention is a control method being executed by a computer. The control method includes 1) a comparison step of comparing a name of a determination target file with a name of one or more comparison target files, and 2) an output step of determining a display manner of information related to the determination target file, depending on whether a name of the determination target file coincides with a name of the comparison target file and according to similarity between a name of the determination target file and a name of the comparison target file, and outputting information related to the determination target file in the determined display manner.

A program according to the present invention causes a computer to execute each step included in the control method according to the present invention.

### Advantageous Effects of Invention

According to the present invention, a technique for improving accuracy of a security analysis that focuses on a name of a file is provided.

### BRIEF DESCRIPTION OF THE DRAWINGS

The above-described object, the other objects, features, and advantages will become more apparent from suitable example embodiments described below and the following accompanying drawings.

FIG. 1 is a diagram representing an outline of an operation of an information processing apparatus according to an example embodiment 1.

FIG. 2 is a diagram illustrating a configuration of the information processing apparatus according to the example embodiment 1.

FIG. 3 is a diagram illustrating a computer for achieving the information processing apparatus.

FIG. 4 is a flowchart illustrating a flow of processing performed by the information processing apparatus according to the example embodiment 1.

FIG. 5 is a first diagram illustrating a scene in which a file to be emphasized is emphasized and output.

FIG. 6 is a second diagram illustrating a scene in which a file to be emphasized is emphasized and output.

FIG. 7 is a diagram illustrating a scene in which a determination target file and a normal name are displayed on a pop-up screen.

FIG. 8 is a block diagram illustrating a functional configuration of an information processing apparatus according to an example embodiment 2.

FIG. 9 is a flowchart illustrating a flow of processing performed by the information processing apparatus according to the example embodiment 2.

FIG. 10 is a block diagram illustrating a functional configuration of an information processing apparatus according to an example embodiment 3.

FIG. 11 is a flowchart illustrating a flow of processing performed by the information processing apparatus according to the example embodiment 3.

FIG. 12 is a diagram illustrating a correction function.

### DESCRIPTION OF EMBODIMENTS

Hereinafter, example embodiments of the present invention will be described with reference to the drawings. Note that, in all of the drawings, the same components have the same reference numerals, and description thereof will be appropriately omitted. Further, in each block diagram, each block represents a configuration of a functional unit instead of a configuration of a hardware unit unless otherwise described.

### Example Embodiment 1

### <Outline>

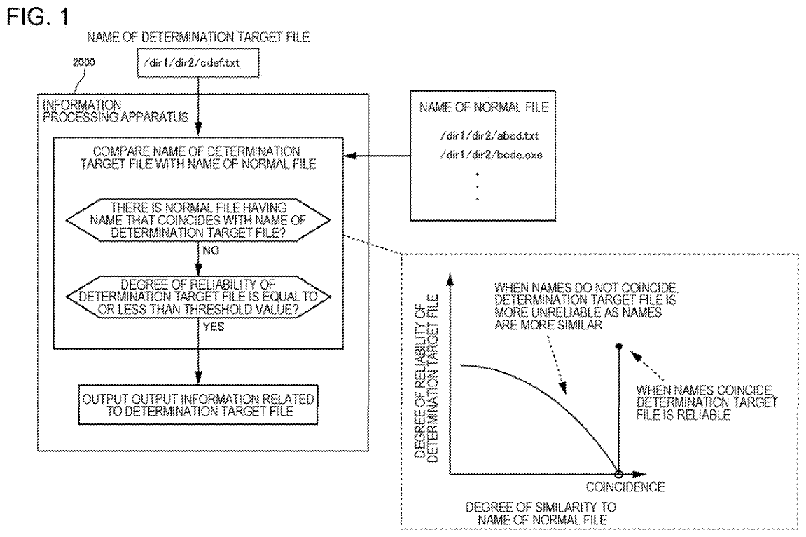

FIG. 1 is a diagram representing an outline of an operation of an information processing apparatus according to an example embodiment 1. FIG. 1 is a schematic diagram for facilitating understanding of the operation of the information processing apparatus 2000, and does not specifically limit the operation of the information processing apparatus 2000.

When a malicious file (i.e., a malicious file disguised as a normal file) having a name similar to a name of a normal file is present on a computer system, there is a high probability that a user accesses the malicious file mistaken for the normal file. The normal file is a file that guarantees validity (safety). For example, the normal file is a file in which validity (safety) is confirmed by being actually used by a user, and a file (for example, a program file installed from a storage medium on the market, and the like) that guarantees validity (safety) by being acquired from a reliable provider. For example, an execution file for operating malware and the like are taken as a malicious file. Then, as a result of an access to such a malicious file, a problem that a malicious attack is made and the like occurs.

Thus, the information processing apparatus 2000 determines whether a determination target file is reliable by comparing a name of the determination target file and a name of a comparison target file. The comparison target file is the normal file mentioned above and the like. Herein, as the name of the determination target file is more similar to a name of the normal file, there is conceivably a higher probability that the determination target file is a malicious file disguised as the normal file. However, when the name of the determination target file coincides with the name of the normal file, it is conceivable that the determination target file is the same as the normal file, and thus there is conceivably a low probability that the determination target file is a malicious file disguised as the normal file. Thus, it is conceivable that a case where a “name of a determination target file does not coincide with but is similar to a name of a normal file” is a case where there is a high probability that the determination target file is disguised as the normal file.

The information processing apparatus 2000 compares a name of a determination target file with a name of a normal file with reference to the point, and outputs output information related to the determination target file when a degree of reliability of the determination target file is low. Specifically, the information processing apparatus 2000 compares a name of a determination target file with a name of one or more normal files, and outputs output information related to the determination target file when 1) a name of the determination target file does not coincide with a name of any of the normal files, and 2) a degree of reliability of the determination target file is equal to or less than a threshold value. Herein, a degree of reliability of the determination target file is calculated, based on a degree of similarity between a name of the determination target file and a name of each of the normal files.

A degree of reliability of a determination target file is calculated in such a way as to have a lower value in a case where there is a higher probability that the determination target file is disguised as a normal file, that is a “name of a determination target file does not coincide with but is similar to a name of a normal file”. For example, a degree of reliability of a determination target file is calculated in such a way as to have a lower value as a maximum value of a degree of similarity calculated between a name of the determination target file and a name of each of normal files is greater when the name of the determination target file does not coincide with the name of any of the normal files. However, as described later, a degree of reliability of a determination target file may be corrected by using an element other than a degree of similarity between a name of the determination target file and a name of a normal file.

### Advantageous Effect

In this way, the information processing apparatus 2000 according to the present example embodiment focuses on a fact that a case where a “name of a determination target file does not coincide with but is similar to a name of a normal file” is a case where there is a high probability that the determination target file is disguised as the normal file, and outputs output information related to the determination target file when 1) a name of the determination target file does not coincide with a name of any of the normal files, and 2) a reliability degree of the determination target file is equal to or less than a threshold value. In this way, a user of the information processing apparatus 2000 can easily recognize presence of a file having a high probability of being disguised as a normal file. In such a manner, the information processing apparatus 2000 according to the present example embodiment can achieve a security analysis with a higher degree of precision by not only determining coincidence/non-coincidence between a name of a determination target file and a name of a normal file but also more specifically comparing the names.

Hereinafter, the information processing apparatus 2000 according to the present example embodiment will be described in more detail.

### <Example of Functional Configuration of Information Processing Apparatus 2000>

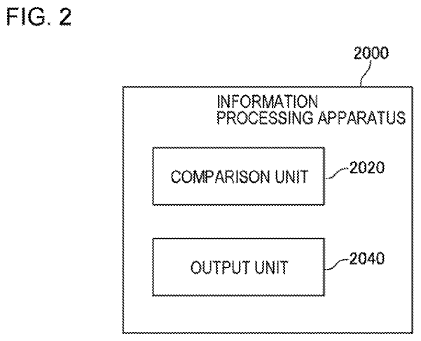

FIG. 2 is a diagram illustrating a configuration of the information processing apparatus 2000 according to the example embodiment 1. The information processing apparatus 2000 includes a comparison unit 2020 and an output unit 2040. The comparison unit 2020 compares a name of a determination target file with one or more normal names (names of normal files). The output unit 2040 outputs output information related to the determination target file when a name of the determination target file does not coincide with a name of any of the normal files, and a degree of reliability of the determination target file is equal to or less than a threshold value. Herein, the comparison unit 2020 calculates a degree of reliability of the determination target file, based on a degree of similarity between a name of the determination target file and a name of each of the normal files.

### <Hardware Configuration of Information Processing Apparatus 2000>

Each functional component unit of the information processing apparatus 2000 may be achieved by hardware (for example, a hard-wired electronic circuit and the like) that achieves each functional component unit, and may be achieved by a combination of hardware and software (for example, a combination of an electronic circuit and a program that controls the electronic circuit and the like). Hereinafter, a case where each functional component unit of the information processing apparatus 2000 is achieved by the combination of hardware and software will be further described.

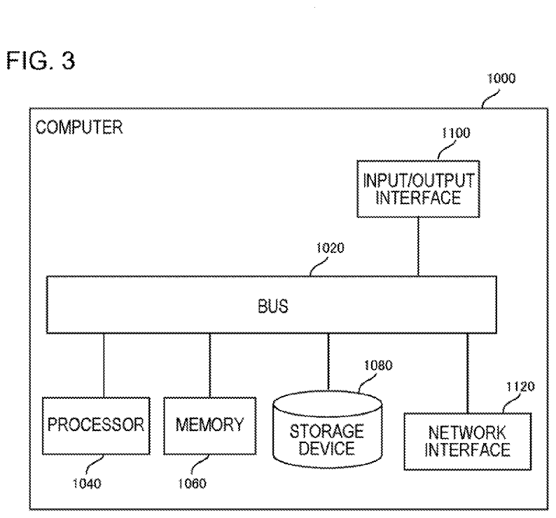

FIG. 3 is a diagram illustrating a computer 1000 for achieving the information processing apparatus 2000. The computer 1000 is any computer. For example, the computer 1000 is a desktop computer such as a personal computer (PC) and a server machine. In addition, for example, the computer 1000 is a portable computer such as a smartphone and a table terminal. The computer 1000 may be a dedicated computer designed for achieving the information processing apparatus 2000, and may be a general-purpose computer.

The computer 1000 includes a bus 1020, a processor 1040, a memory 1060, a storage device 1080, an input/output interface 1100, and a network interface 1120. The bus 1020 is a data transmission path for allowing the processor 1040, the memory 1060, the storage device 1080, the input/output interface 1100, and the network interface 1120 to transmit and receive data with one another. However, a method of connecting the processor 1040 and the like to each other is not limited to a bus connection.

The processor 1040 is various types of processors such as a central processing unit (CPU), a graphic processing unit (GPU), and a field-programmable gate array (FPGA). The memory 1060 is a main storage apparatus achieved by using a random access memory (RAM) and the like. The storage device 1080 is an auxiliary storage apparatus achieved by using a hard disk, a solid state drive (SSD), a memory card, a read only memory (ROM), or the like.

The input/output interface 1100 is an interface for connecting the computer 1000 and an input/output device. For example, an input apparatus such as a keyboard and an output apparatus such as a display apparatus are connected to the input/output interface 1100.

The network interface 1120 is an interface for connecting the computer 1000 to a communication network. The communication network is, for example, a local area network (LAN) and a wide area network (WAN). A method of connection to the communication network by the network interface 1120 may be a wireless connection or a wired connection.

The storage device 1080 stores a program module that achieves each functional component unit of the information processing apparatus 2000. The processor 1040 achieves a function associated with each program module by reading each of the program modules to the memory 1060 and executing the program module.

### <Flow of Processing>

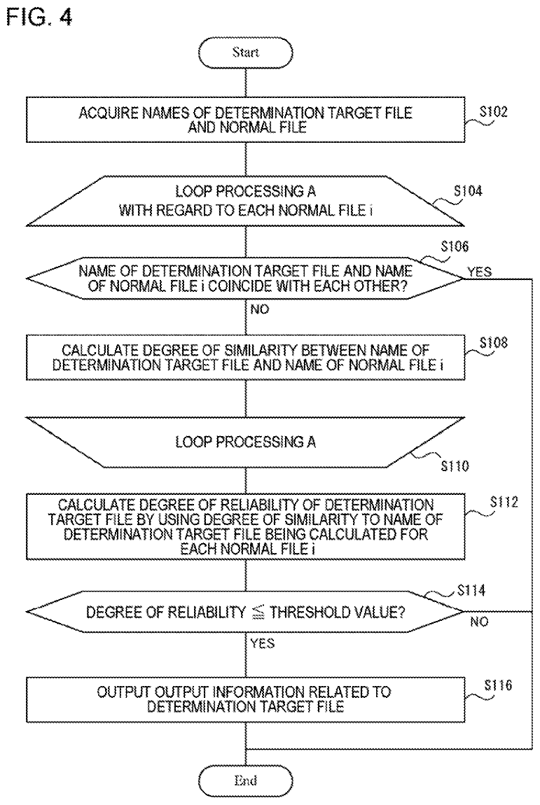

FIG. 4 is a flowchart illustrating a flow of processing performed by the information processing apparatus 2000 according to the example embodiment 1. The comparison unit 2020 acquires a name of a determination target file and a normal file (S102). S104 to S110 are loop processing A performed on each of one or more normal files as a target. In S104, the comparison unit 2020 determines whether the loop processing A has already been performed on all of the normal files as a target. When the loop processing A has already been performed on all of the normal files as a target, the processing in FIG. 4 proceeds to S112. On the other hand, when a normal file that is not yet a target of the loop processing A is present, the comparison unit 2020 selects one of the normal files, and the processing in FIG. 4 proceeds to S106. The normal file selected herein is expressed as a normal file i.

The comparison unit 2020 determines whether the name of the determination target file and a name of the normal file i coincide with each other (S106). When the names coincide with each other (S106: YES), the processing in FIG. 4 ends. On the other hand, when the names do not coincide with each other (S106: NO), the comparison unit 2020 calculates a degree of similarity between the name of the determination target file and the name of the normal file i (S108). S110 is an end of the loop processing A, and thus the processing in FIG. 4 proceeds to S104.

In S112 (i.e., after the loop processing A ends), the comparison unit 2020 calculates a degree of reliability of the determination target file by using the degree of similarity to the name of the determination target file being calculated for each of the normal files i.

The output unit 2040 determines whether the degree of reliability of the determination target file is equal to or less than a threshold value (S114). When the degree of reliability of the determination target file is equal to or less than the threshold value (S114: YES), the output unit 2040 outputs output information. On the other hand, when the degree of reliability of the determination target file is not equal to or less than the threshold value (S114: NO), the processing in FIG. 4 ends.

Herein, a flow of the processing performed by the information processing apparatus 2000 is not limited to that illustrated in FIG. 4. For example, the output unit 2040 may be configured to output output information even when a normal file having a name that coincides with a name of a determination target file is present (S106: YES) and when a degree of reliability of the determination target file is greater than the threshold value (S114: NO). However, the output information output in this case is different from output information output when a normal file having a name that coincides with a name of a determination target file is not present and a degree of reliability of the determination target file is equal to or less than the threshold value (S114: YES). A specific difference will be described later.

Further, the comparison unit 2020 may be configured to calculate a degree of similarity between a name of a determination target file and a normal name, and determine whether the name of the determination target file and the normal name coincide with each other by using the calculated degree of similarity, instead of being configured to determine whether a name of a determination target file and a normal name coincide with each other before calculation of a degree of similarity is performed.

### <Acquisition of Name of Determination Target File: S102>

The comparison unit 2020 acquires a name of a determination target file (S102). There are various types of methods of acquiring a name of a determination target file. For example, the comparison unit 2020 acquires a name of a determination target file by receiving an input that specifies the determination target file from a user of the information processing apparatus 2000. Herein, the specified determination target file may be one or plural. In a latter case, for example, the comparison unit 2020 acquires, as a name of a determination target file, a name of each file subordinate to a directory by receiving a specification of the directory.

In addition, for example, the comparison unit 2020 acquires, as a name of a determination target file, a name of all files present in a target system, and a name of one or more files specified in advance among files present in a target system. In this case, for example, the information processing apparatus 2000 performs a series of processing illustrated in FIG. 4 at a regular timing, a timing at which a specific event (for example, activation of the target system and the like), or the like.

In addition, for example, when a specific event (for example, a file access) targeted at a file occurs, the comparison unit 2020 may acquire, as a name of a determination target file, a name of the file being a target of the event.

Herein, when a plurality of names of determination target files are acquired, a series of the processing (see FIG. 4) is performed with a name of each of the determination target files as a target.

### <Acquisition of Normal Name: S102>

The comparison unit 2020 acquires one or more normal names (S102). For example, the comparison unit 2020 acquires a normal name by acquiring a normal name list in which one or more normal names are indicated. For example, the normal name list is generated by listing a name of a file present in a system after a clean install. In addition, for example, the normal name list is generated by listing a name of one or more normal files having an instance of being disguised being present, based on an instance such as malware damage.

There are various types of methods of acquiring a normal name list by the comparison unit 2020. For example, the comparison unit 2020 acquires a normal name list by accessing a storage apparatus that stores the normal name list. In addition, for example, the comparison unit 2020 may acquire a normal name list by receiving the normal name list transmitted from another apparatus.

### <With Regard to Name of File>

Various names of a file can be used. For example, a file name, a path name, a URL, or the like can be used. Which name is to be used among names that can be used as a name of a file may be determined in advance, or may be able to be set by a user.

When a path name is used as a name, the comparison unit 2020 may be configured to use only a part of the path name for a comparison. For example, how many directories at a higher level from a file name are set as a comparison target is set in advance. For example, it is assumed that a path of a determination target file is “dirA/dirB/dirC/fileX.txt”, and the number of directories as a comparison target is two. In this case, a portion of “dirB/dirC/fileX.txt” of the path of the determination target file is used for a comparison. The same also applies to a normal name.

The number of directories as a comparison target may be fixedly determined, or may be able to be specified by a user.

A character string (such as a user name and a machine name) unique to a usage environment may be included in a part of a path name. It is suitable to exclude such a character string unique to a usage environment from a target for a comparison. For example, a portion of a normal name representing such a character string unique to a usage environment is represented in advance by a specific character (hereinafter, an exclusion character) such as a mask character. The comparison unit 2020 excludes a portion of a normal name being an exclusion character, and then compares a name of a determination target file and the normal name.

Further, a control character such as a Unicode control character may be included in a path name and a file name. For example, there are a control character (hereinafter, expressed as [RLO]) that is “Start of Right-to-Left Override (read right to left from here)” and the like. Normally, a path name including such a control character is subjected to processing of applying the control character before the path name is brought to a notice of a user (for example, before the path name is displayed on a display apparatus). For example, when data of a path name are “file[RLO]X.txt”, a path name output to a display apparatus is “filetxt.X”.

Herein, in the information processing apparatus 2000, it is suitable to determine whether a determination target file is reliable, based on “whether a name of a determination target file is mixed up with a name of a normal file from a point of view of a user”. Thus, it is more suitable to compare a name of a determination target file and a normal name as character strings output to the outside of a display and the like than as data handled inside a system.

Thus, the comparison unit 2020 determines whether a control character is included in a name of a determination target file before comparing the name of the determination target file with a normal name. Then, when the control character is included in the name of the determination target file, the comparison unit 2020 generates a name of the determination target file when being output to the outside by applying the control character to the name of the determination target file. Then, the comparison unit 2020 compares the generated name and a normal name. For example, when a name of a determination target file is “file[RLO]X.txt”, the comparison unit 2020 generates a file name “filetxt.X” to which the control character RLO is applied, and compares the “filextx.X” with a normal name. Note that, also, when a control character is included in a normal name, similarly, a name to which the control character is applied is generated and then compared.

### <Coincidence Determination: S106>

The comparison unit 2020 determines whether the name of the determination target file and the name of the normal file coincide with each other (S106). Herein, an existing technique can be used as a method of determining whether two character strings coincide with each other.

### <Calculation of Degree of Similarity: S108>

The comparison unit 2020 calculates a degree of similarity between the name of the determination target file and the normal name (S108). For calculation of a degree of similarity between a name of a determination target file and a normal name, an index value (hereinafter, a distance index value) representing a distance between character strings can be used. As an example of the distance index value, there are a Levenshtein distance and the like.

Herein, it can be said that a normal name having a shorter distance to a determination target file has a higher degree of similarity to the determination target file. Thus, for example, the comparison unit 2020 calculates, as a degree of similarity between a name of a determination target file and a normal name, a value (such as a reciprocal of a distance index value) that increases as a distance index value decreases.

### <<Correction of Degree of Similarity>>

The comparison unit 2020 may correct, by using another index, a degree of similarity calculated by using a distance between character strings. For example, a rule (hereinafter, a first correction rule) for correcting a degree of similarity calculated by using a distance between character strings is determined in advance. The first correction rule is stored in advance in a storage apparatus that can be accessed from the comparison unit 2020.

A rule for performing correction in such a way as to increase a degree of similarity of a pair of characters being mixed up from a point of view of a person is taken as one example of the first correction rule. As characters being mixed up from a point of view of a person, there are, for example, “1 and 1 (one and an 1)”, “0 and 0 (zero and an 0)”, “6 and b (six and a b), and the like.

When such a first correction rule is determined, the comparison unit 2020 corrects, in consideration of a presence of a pair of characters included in the first correction rule, a degree of similarity calculated based on a distance between a name of a determination target file and a normal name. For example, a specific weight (a real number more than one) is determined in advance for each pair of characters registered in the first correction rule. The comparison unit 2020 detects a pair of characters determined in the first correction rule from among a name of determination target file and a normal name. When a pair of characters determined in the first correction rule is detected, the comparison unit 2020 corrects a degree of similarity by multiplying the degree of similarity by a weight of the detected pair of the characters.

A degree of similarity between a name of a determination target file and a normal name can be calculated by using the above-mentioned first correction rule in consideration of visual confusion in addition to a distance between character strings.

### <Calculation of Degree of Reliability: S112>

The comparison unit 2020 calculates a degree of reliability of the determination target file, based on the degree of similarity of the determination target file being calculated for each normal file (S112). For example, the comparison unit 2020 sets, as a degree of reliability of a determination target file, a maximum degree of similarity (i.e., a maximum value of a degree of similarity) among calculated degrees of similarity.

### <<Correction of Degree of Reliability>>

The comparison unit 2020 may correct a degree of reliability of a determination target file. For example, a rule (hereinafter, a second correction rule) for correcting a degree of reliability calculated by using a degree of similarity is determined in advance. The second correction rule is stored in advance in a storage apparatus that can be accessed from the comparison unit 2020.

As one example of the second correction rule, a rule for determining, for each normal file, a weight based on a degree of freedom in an arrangement of a normal file is conceivable. A degree of freedom in an arrangement of a file varies by the file. For example, there is a file that can be disposed in a free directory by a user, such as an execution file of free software, whereas there is a file having an arrangement place being fixed, such as a system file used by an operating system (OS). It can be said that the former has a higher degree of freedom, and the latter has a lower degree of freedom.

Thus, for example, in the second correction rule, a greater weight is determined for each normal file as a degree of freedom in an arrangement of the normal file is lower. The comparison unit 2020 performs correction of a degree of reliability of a determination target file by multiplying the degree of reliability by a weight determined for the normal file.

### <Output of Result: S116>

The output unit 2040 performs outputting, based on a result of the comparison by the comparison unit 2020 (S116). For example, the output unit 2040 outputs, in a manner (emphasized manner) different from a name of another file, a name of a determination target file that satisfies two conditions in which 1) there is no same normal name as the name of the determination target file, and 2) a degree of reliability of the determination target file being calculated by the comparison unit 2020 is equal to or less than a threshold value. In this way, a user can recognize a name of a determination target file having a high probability of being disguised as a normal file. Hereinafter, a condition (AND of the two conditions) combining the two conditions described above is referred to as an emphasis condition. Further, a determination target file to be emphasized and output is also referred to as a “file to be emphasized”. Note that a threshold value of a degree of reliability may be set in advance by the output unit 2040, and may be stored in a storage apparatus that can be accessed from the output unit 2040.

Herein, for a determination target file, there may be three types of cases that is 1) a case where a normal name and a name do not coincide with each other and a degree of reliability is equal to or less than a threshold value, 2) a case where a normal name and a name do not coincide with each other, but a degree of reliability is greater than a threshold value, and 3) a normal name and a name coincide with each other. For example, the output unit 2040 performs outputting in manners different from each other in the three types of the cases. In other words, the information processing apparatus 2000 determines a display manner of information related to a determination target file depending on whether a name of the determination target file coincides with a name of a comparison target file and according to similarity between the name of the determination target file and the name of the comparison target file, and outputs the information related to the determination target file in the determined display manner.

For example, the output unit 2040 performs emphasized outputting for a determination target file corresponding to 1) and a determination target file corresponding to 2), and performs outputting (normal outputting without particularly changing display) without emphasizing for a determination target file corresponding to 3). Further, it is assumed that the output unit 2040 sets a higher degree of emphasizing for outputting in the case corresponding to 1) than outputting in the case corresponding to 2).

There are various types of specific methods of emphasizing. For example, the information processing apparatus 2000 performs emphasizing in methods of 1) displaying a name of a file to be emphasized with a character in a more conspicuous color than a normal color, 2) displaying a name of a file to be emphasized with a character having a size larger than a normal size, 3) displaying an icon representing a file to be emphasized in a size larger than a normal size, and 4) displaying a name of a file to be emphasized on a pop-up screen. In the examples, the “degree of emphasizing” mentioned above refers to a conspicuous degree of color, a size of a character, a size of an icon, whether to use a pop-up screen, and the like.

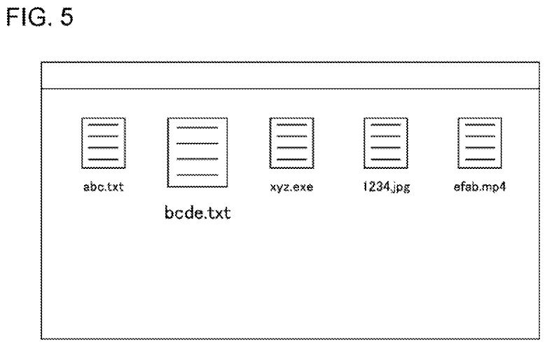

FIG. 5 is a first diagram illustrating a scene in which a file to be emphasized is emphasized and output. FIG. 5 illustrates a case where a directory specified by a user is deployed and displayed. Such processing is performed when, for example, an icon of a directory is double-clicked in a GUI interface.

The comparison unit 2020 handles, as a determination target file, each file included in a specified directory, and identifies a file to be emphasized by determining whether each determination target file satisfies an emphasis condition. The output unit 2040 displays a file specified to be emphasized among the determination target files included in the specified directory in a more emphasized manner than a file that is not specified to be emphasized.

In FIG. 5, it is determined that a file that is “bcde.txt” satisfies an emphasis condition. Thus, an icon of the file is larger than an icon of another file, and a name that is “bcde.txt” is displayed in a size larger than a normal size.

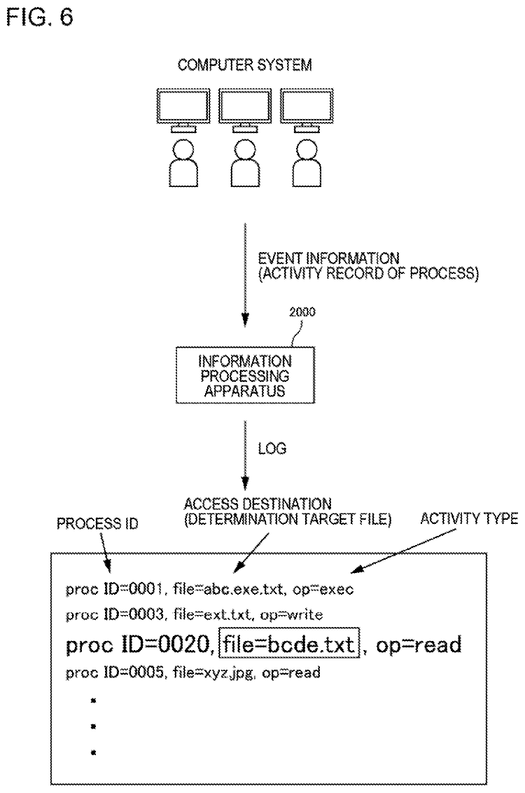

FIG. 6 is a second diagram illustrating a scene in which a file to be emphasized is emphasized and output. In this example, information (hereinafter, event information) related to an event that occurs on a computer system is output. For example, the event information represents an activity and the like of a process. For example, a problem (such as a presence of malware) on a computer system can be found by analyzing the event information by a security analyst.

Herein, event information in FIG. 6 includes a name of a file, such as a name of a file accessed by a process and an execution file of a process. A name of such a file is also a determination material for a security analyst. For example, when it is clear that an execution file of a certain process is a file having a high probability of being disguised as a normal file, it is clear that there is a high probability that malware has been executed. Further, behavior of malware can also be analyzed by analyzing behavior of the process.

Thus, the output unit 2040 performs a determination with, as a determination target file, each file included in event information, and performs emphasized outputting for event information including a determination target file that satisfies an emphasis condition. In FIG. 6, event information related to a determination target file that satisfies an emphasis condition is displayed in a size larger than that of other event information. Furthermore, a name of the determination target file is surrounded by a rectangle in the event information displayed in a larger size.

By such emphasized display, a security analyst and the like can easily recognize a file having a high probability of being disguised as a normal file and an event related to the file. Herein, for a file having a name similar to a name of a normal file, there is a risk that a security analyst who visually checks event information may mistake the event information for an event related to the normal file and overlook the event information. Thus, performing such emphasized display can prevent overlooking by a security analyst.

Herein, only when a name of a determination target file satisfies an emphasis condition, the output unit 2040 may output the name of the determination target file. For example, the comparison unit 2020 sequentially handles, as a determination target file, a file included in a certain computer system, and determines whether each determination target file satisfies an emphasis condition. The comparison unit 2040 outputs a name of the determination target file determined to satisfy the emphasis condition. In this way, the information processing apparatus 2000 can detect a file having a high probability of being disguised as a normal file from among files included in the computer system. Then, a user of the information processing apparatus 2000 can recognize a file having a high probability of being disguised as a normal file.

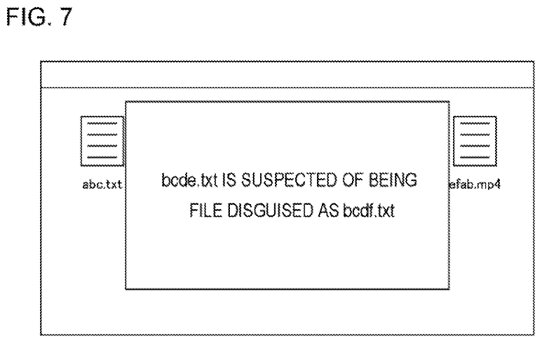

Further, the output unit 2040 may output a name of a determination target file that satisfies an emphasis condition together with a normal name having a high degree of similarity to the name of the determination target file. FIG. 7 is a diagram illustrating a scene in which a determination target file and a normal name are displayed on a pop-up screen. In this way, a name of a determination target file that satisfies an emphasis condition is output together with a normal name having a high degree of similarity to the name of the determination target file, and thus a user of the information processing apparatus 2000 can recognize the determination target file having a high probability of being disguised as a normal file and can also recognize the normal file having a high probability of being disguised.

A normal name output together with a name of a determination target file is, for example, a normal name having a maximum degree of similarity to a name of a determination target file. In addition, for example, a threshold value may be provided for a degree of similarity, and all normal names whose degree of similarity to a name of a determination target file is equal to or more than the threshold value may be output together with the determination target file. In addition, for example, a predetermined number of normal names among normal names whose degree of similarity is equal to or more than a threshold value may be output in a descending order of degree of similarity. A threshold value of a degree of similarity may be set in advance by the output unit 2040, and may be stored in a storage apparatus that can be accessed from the output unit 2040.

Note that a message indicating that a determination target file has a high probability of being disguised as a normal file may be included in output when an emphasis condition is satisfied. For example, the output unit 2040 displays a name of a determination target file, a name of a normal file having a high degree of similarity to the name of the determination target file, and a pop-up screen including the message described above.

<<With Regard to Case where Plurality of Threshold Values of Degree of Reliability are Provided>>

A plurality of threshold values compared with a degree of reliability calculated by the comparison unit 2020 may be provided. In this case, the comparison unit 2020 may set a different manner of output depending on which threshold value a degree of reliability of a determination target file is equal to or less than. In this case, it is preferable that output is performed in a manner in which information related to the determination target file is more emphasized as the degree of reliability is equal to or less than a smaller threshold value.

For example, it is assumed that a first threshold value Th1 and a second threshold value Th2 are provided as a threshold value, and Th1>Th2. In this case, for example, the output unit 2040 outputs a name of a determination target file when a degree of reliability R of the determination target file is equal to or less than the first threshold value. At this time, the output unit 2040 performs different emphasizing in a case of “Th2<R<=Th1” and a case of “R<=Th2”. For example, the output unit 2040 outputs a name of a determination target file with a yellow character in the case of “Th2<R<=Th1”, and outputs a name of a determination target file with a red character in the case of “R<=Th2”. In this way, by changing a manner of emphasizing, a user of the information processing apparatus 2000 can intuitively recognize how high (degree that attention is paid to a determination target file) a probability that a determination target file is disguised is.

Herein, a method of setting a different method of emphasizing depending on which threshold value a degree of reliability is equal to or less than is not limited to only a method of setting a different color of a character of a name of a determination target file, and can be a combination of any methods. For example, the output unit 2040 outputs a name of a determination target file in a size larger than a normal size in the case of “Th2<R<=Th1”, and displays a name of a determination target file on a pop-up screen in the case of “R<=Th2”.

### Example Embodiment 2

An information processing apparatus 2000 according to an example embodiment 2 takes an electronic signature provided to a determination target file into consideration. An electronic signature may be provided to a file. An electronic signature can be used for confirming a provider of a file and confirming that a file is not falsified. Thus, when an electronic signature is provided to a determination target file, whether the determination target file is reliable can be more accurately determined by using the electronic signature.

Thus, for example, the information processing apparatus 2000 according to the example embodiment 2 determines whether an electronic signature is provided to a determination target file, and performs verification thereof when the electronic signature is provided. Then, the information processing apparatus 2000 corrects a degree of reliability of the determination target file, based on a result of the verification. For example, when it is determined that a determination target file is not falsified, correction of a degree of reliability is performed in such a way as to increase a degree of reliability of the determination target file further than that when it is determined that the determination target file is falsified.

In addition, for example, when it is determined from verification of an electronic signature that a determination target file is reliable, the information processing apparatus 2000 may omit calculation of a degree of reliability of the determination target file, and handle the determination target file similarly to a case where a name of a determination target file and a normal name coincide with each other. In other words, in this case, the emphasis condition mentioned above is an AND of three conditions in which 1) there is no same normal name as a name of a determination target file, 2) as a result of verification of an electronic signature, it is not determined that a determination target file is reliable, and 3) a degree of reliability of a determination target file being calculated by the comparison unit 2020 is equal to or less than a threshold value.

### Advantageous Effect

According to the information processing apparatus 2000 in the present example embodiment, an electronic signature provided to a determination target file is used for a determination of whether the determination target file is disguised as a normal file. Since an electronic signature can be used for confirming that a file is not falsified and the like, whether a determination target file is disguised as a normal file can be more accurately determined by using the electronic signature.

Hereinafter, the information processing apparatus 2000 according to the present example embodiment will be described in more detail.

### <Example of Functional Configuration>

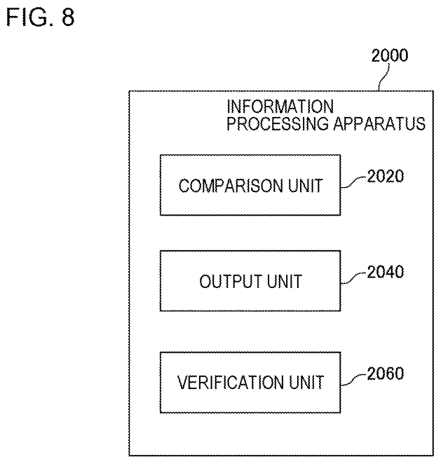

FIG. 8 is a block diagram illustrating a functional configuration of the information processing apparatus 2000 according to the example embodiment 2. The information processing apparatus 2000 according to the example embodiment 2 includes a verification unit 2060. The verification unit 2060 determines whether an electronic signature is provided to a determination target file. When an electronic signature is provided to a determination target file, the verification unit 2060 performs verification of the electronic signature. The verification unit 2060 performs outputting based on a result of a comparison by a comparison unit 2020 and a result of verification of an electronic signature by the verification unit 2060.

### <Example of Hardware Configuration>

Various types of hardware configurations can be adopted for the information processing apparatus 2000 according to the example embodiment 2 similarly to the information processing apparatus 2000 according to the example embodiment 1. For example, a hardware configuration of the information processing apparatus 2000 according to the example embodiment 2 is represented in FIG. 3 similarly to the hardware configuration of the information processing apparatus 2000 according to the example embodiment 1. However, a program module that achieves a function of the information processing apparatus 2000 according to the example embodiment 2 is stored in a storage device 1080 according to the example embodiment 2.

### <Flow of Processing>

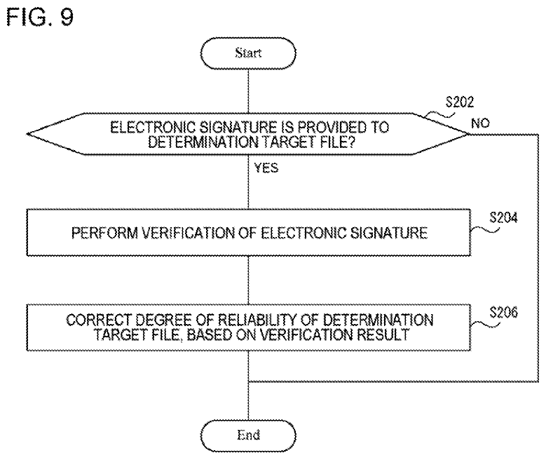

FIG. 9 is a flowchart illustrating a flow of processing performed by the information processing apparatus 2000 according to the example embodiment 2. The verification unit 2060 determines whether an electronic signature is provided to a determination target file (S202). When the electronic signature is provided (S202: YES), the verification unit 2060 performs verification of the electronic signature (S204). The verification unit 2060 corrects a degree of reliability of the determination target file by using the verification result (S206).

There are various timings at which a series of the processing illustrated in FIG. 9 is performed. For example, the processing is performed after a degree of reliability of a determination target file is calculated (between S112 and S114 in FIG. 4). Further, as mentioned above, when it is determined from verification of an electronic signature that a determination target file is reliable, and calculation of a degree of reliability of the determination target file is thus omitted, a series of the processing illustrated in FIG. 9 may be performed before a comparison with a normal name starts (for example, before S102 in FIG. 4).

### <Determination of Whether Electronic Signature is Provided: S202>

The verification unit 2060 determines whether an electronic signature is provided to a determination target file (S202). An existing technique can be used as a technique for determining whether an electronic signature is provided to a specific file.

### <Verification of Electronic Signature: S204>

The verification unit 2060 performs verification of the electronic signature provided to the determination target file (S204). For example, the verification unit 2060 performs verification for any one or more items among three verification items that are 1) verification that current time falls within an expiration date of an electronic signature, 2) verification that a provider of a determination target file indicated in an electronic signature is reliable, and 3) verification that a determination target file is not falsified. The verification of 2) can be achieved by, for example, determining whether a Certification Authority that issues an electronic signature is a reliable Certification Authority registered in advance in the information processing apparatus 2000. An existing technique can be used as a specific method of the three types of the verification.

Hereinafter, for the verification of 1), it is assumed that a case where current time falls within an expiration date of an electronic signature is a verification success, and a case where current time does not fall within an expiration date of an electronic signature is a verification failure. Further, for the verification of 2), it is assumed that a case where a provider of a determination target file indicated in an electronic signature is reliable is a verification success, and a case where a provider of a determination target file indicated in an electronic signature is not reliable is a verification failure. Furthermore, for the verification of 3), it is assumed that a case where a determination target file is not falsified is a verification success, and a case where a determination target file is falsified is a verification failure.

### <Use of Verification Result>

There are various types of methods of using a result of verification by the verification unit 2060. For example, when all verification performed by the verification unit 2060 succeeds, the output unit 2040 handles an emphasis condition being unsatisfied similarly to a case where a normal name that coincides with a name of a determination target file is not present. The reason is that a degree of reliability of a determination target file is conceivably high when all verification using an electronic signature succeeds.

In addition, for example, the comparison unit 2020 corrects a degree of reliability of the determination target file, based on a result of the verification by the verification unit 2060 (S206). Conceptually, a degree of reliability when verification succeeds is set higher than a degree of reliability when verification fails.

For example, a first weight used when verification succeeds is determined in advance for each verification item. The first weight is a real number greater than one. When verification of a certain verification item succeeds, the verification unit 2060 corrects a degree of reliability of a determination target file by multiplying the degree of reliability by the first weight determined for the verification item. In this way, when the verification succeeds, the degree of reliability increases.

In addition, for example, a second weight used when verification fails is determined in advance for each verification item. The second weight is a positive real number smaller than one. When verification of a certain verification item fails, the verification unit 2060 corrects a degree of reliability of a determination target file by multiplying the degree of reliability by the second weight determined for the verification item. In this way, when the verification fails, the degree of reliability decreases.

Any one of or both of the correction using the first weight and the correction using the second weight may be performed.

Note that the first weight determined for each verification item may be a common value or may each be a different value. The same also applies to the second weight. The first weight and the second weight may be set in advance in the comparison unit 2020, and may be stored in a storage apparatus that can be accessed from the comparison unit 2020.

<With Regard to Case where Electronic Signature is not Provided>

For a case where an electronic signature is not provided, correction of a degree of reliability may not be performed or may be performed. In a latter case, for example, when it is determined that an electronic signature is not provided to a determination target file, the comparison unit 2020 corrects a degree of reliability of the determination target file in such a way as to reduce the degree of reliability. In this way, a fact that an electronic signature is not provided can be handled as a factor in reducing a degree of reliability of a determination target file.

### <Other Use Method of Electronic Signature>

A verification result of an electronic signature may be used for determining the number of levels (the number of directories) used for a comparison when a part of a path name is used for the comparison. Hereinafter, the number of levels used for a comparison is referred to as a comparison level number.

Since a file provided with an electronic signature that succeeds in verification has a high probability of being a normal file, there is a high probability that the file is stored in a normal position on a file system. Thus, it is conceivable that a comparison level number may be small. On the other hand, since a file without an electronic signature being provided or a file provided with an electronic signature that fails in verification has a high probability of not being a normal file, the file is not necessarily stored in a normal position on a file system.

Thus, for example, the comparison unit 2020 sets a comparison level number when verification of an electronic signature fails to a value greater than a comparison level number when verification of an electronic signature succeeds. For example, a first comparison level number used when any one or more verification fails and a second comparison level number used when all verification succeeds are determined in advance in such a way as to satisfy “first comparison level number>second comparison level”.

In addition, for example, the comparison unit 2020 may set a comparison level number when an electronic signature is not provided to a determination target file to a value greater than a comparison level number when an electronic signature is provided to a determination target file. For example, a third comparison level number used when an electronic signature is not provided to a determination target file and a fourth comparison level number used when an electronic signature is provided to a determination target file are determined in advance in such a way as to satisfy “third comparison level number>fourth comparison level”.

Each comparison level number mentioned above may be set in advance in the comparison unit 2020, and may be stored in a storage apparatus that can be accessed from the comparison unit 2020.

### Example Embodiment 3

### <Outline>

A plurality of files having the same name may be present on a computer system. For example, in a computer system including a plurality of machines, a file having the same name may be present in each of one or more machines.

Herein, when a case where only a few files having a certain name are present and a case where many files having the certain name are present are compared, it is conceivable that a degree of reliability of a file having the certain name is higher in the latter case. Thus, the information processing apparatus 2000 according to the example embodiment 3 recognizes a presence number of files having the same name as that of a determination target file, and performs correction of a degree of reliability of the determination target file in such a way as to increase the degree of reliability as the presence number is greater. In this way, whether a determination target file is disguised as a normal file can be more accurately determined.

Hereinafter, the information processing apparatus 2000 according to the present example embodiment will be described in more detail.

### <Example of Functional Configuration>

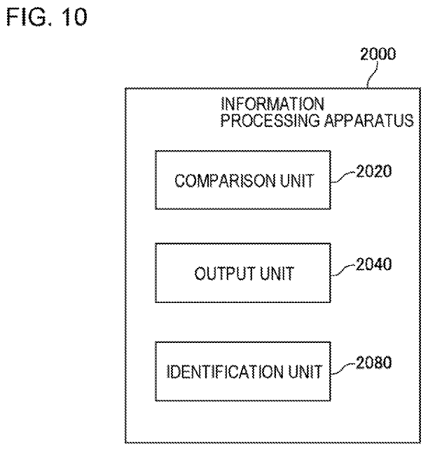

FIG. 10 is a block diagram illustrating a functional configuration of the information processing apparatus 2000 according to the example embodiment 3. The information processing apparatus 2000 according to the example embodiment 3 includes an identification unit 2080. The identification unit 2080 identifies a presence number of files having a name of a determination target file. A comparison unit 2020 corrects a degree of reliability of the determination target file, based on the identified presence number.

### <Example of Hardware Configuration>

Various types of hardware configurations can be adopted for the information processing apparatus 2000 according to the example embodiment 3 similarly to the information processing apparatus 2000 according to the example embodiment 1. For example, a hardware configuration of the information processing apparatus 2000 according to the example embodiment 3 is represented in FIG. 3 similarly to the hardware configuration of the information processing apparatus 2000 according to the example embodiment 1. However, a program module that achieves a function of the information processing apparatus 2000 according to the example embodiment 3 is stored in a storage device 1080 according to the example embodiment 3.

### <Flow of Processing>

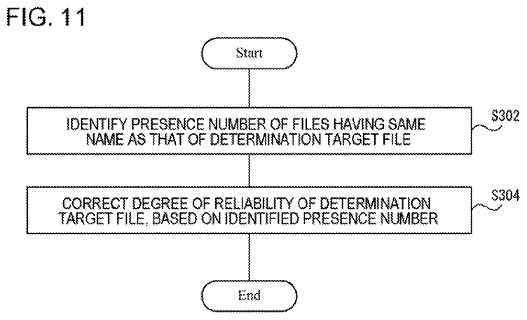

FIG. 11 is a flowchart illustrating a flow of processing performed by the information processing apparatus 2000 according to the example embodiment 3. The identification unit 2080 identifies a presence number of files having the same name as that of a determination target file (S302). The comparison unit 2020 corrects a degree of reliability of the determination target file, based on the identified presence number (S304).

### <Identification of Presence Number: S302>

The identification unit 2080 identifies a presence number of files having the same name as that of a determination target file (S302). For example, a history of a name of a file to be determined in the past is stored in advance in any storage apparatus. Hereinafter, the history is referred to as a determination history. For example, the identification unit 2080 searches a determination history, and identifies, as a presence number of determination target files, the number of histories with regard to a file having the same name as that of the determination target file.

Herein, it is suitable that the number of determination target files is counted for each usage environment. In other words, when a determination is performed for a plurality of times on files having the same name present in the same usage environment, the number of the files is counted for only once. Note that the usage environment is, for example, a machine and a user account.

When a usage environment is taken into consideration, a name of a file to be determined and a usage environment thereof are stored in advance in association with each other in a determination history. For example, a user ID, a universally unique identifier (UUID) of a machine, or a network address such as an IP address can be used as an identifier of a usage environment. Then, the identification unit 2080 searches a determination history, counts the number of histories with regard to a file having the same name as that of a determination target file in a usage environment unit, and sets the count result to a presence number of files having the same name as that of the determination target file. Note that, when a portion unique to a usage environment such as a user ID is included in a name of a file, the portion is excluded, and a coincidence of the name is determined.

### <Correction of Degree of Reliability: S304>

The comparison unit 2020 adjusts a degree of reliability of the determination target file, based on the presence number of files having the same name as that of the determination target file being identified by the identification unit 2080 (S304). For example, a correction function representing a rule for converting a presence number of determination target files to a correction coefficient is determined in advance. The comparison unit 2020 performs correction of a degree of reliability of a determination target file by multiplying the degree of reliability by a correction coefficient acquired by inputting the presence number identified by the identification unit 2080 into the function.

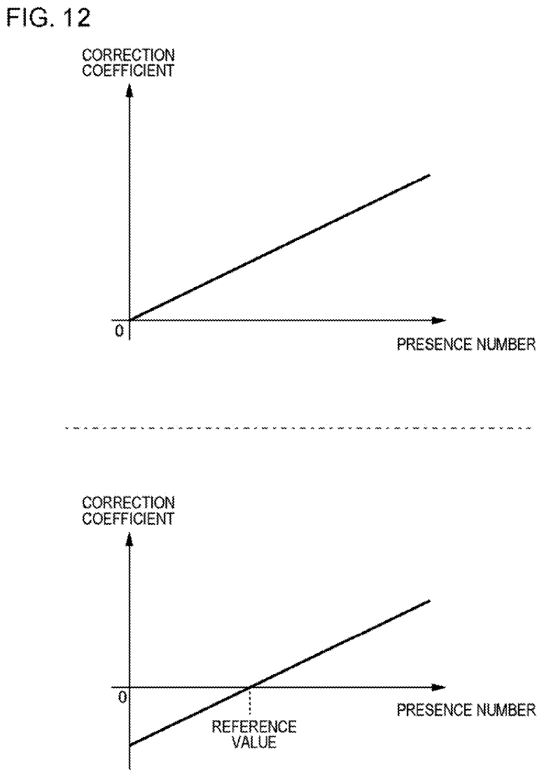

FIG. 12 is a diagram illustrating a correction function. In an upper row in FIG. 12, a correction function is a monotone increasing function that outputs one when a presence number of files having the same name as that of a determination target file is zero, and outputs a value greater than one when a presence number of files having the same name as that of a determination target file is one. In this case, a degree of reliability does not decrease due to correction.

In contrast, a correction function in a lower row in FIG. 12 is a monotone increasing function that compares a presence number of files having the same name as that of a determination target file with a reference value, and each outputs a value smaller than one when the presence number is less than the reference value, outputs one when the presence number is equal to the reference value, and outputs a value greater than one when the presence number is greater than the reference value. By using the correction function, when the number of files having the same name as that of a determination target file is smaller than a reference value, a degree of reliability is set to a value smaller than that before correction.

While the example embodiments of the present invention have been described with reference to the drawings, the example embodiments are only exemplification of the present invention, and combination of each of the above-described example embodiments or various configurations other than the above-described example embodiments can also be employed.

A part or the whole of the above-described example embodiments may also be described as in supplementary notes below, which is not limited thereto.

1. An information processing apparatus, including:
a comparison unit that compares a name of a determination target file with a name of one or more comparison target files; and
an output unit that outputs information related to the determination target file, when a name of the determination target file does not coincide with a name of any of the comparison target files, and a degree of reliability of the determination target file is equal to or less than a threshold value, wherein
the comparison unit calculates a degree of reliability of the determination target file, based on a degree of similarity between a name of the determination target file and a name of each of the comparison target files.
   2. The information processing apparatus according to supplementary note 1, wherein
a name used for a comparison by the comparison unit is any one or more of a file name, a path name, and a URL of a file.
   3. The information processing apparatus according to supplementary note 1 or 2, wherein
the output unit outputs information related to the determination target file in a more emphasized manner than another case, when a name of the determination target file does not coincide with a name of the comparison target file, and a degree of reliability of the determination target file is equal to or less than a threshold value.
   4. The information processing apparatus according to supplementary note 3, wherein
the output unit performs different emphasizing on information related to the determination target file when a maximum value of a degree of similarity calculated between names of the determination target file and the comparison target file is equal to or less than a first threshold value and greater than a second threshold value, and when the maximum value is equal to or more than the second threshold value.
   5. The information processing apparatus according to any one of supplementary notes 1 to 4, wherein
the comparison unit calculates a degree of similarity between a name of the determination target file and a name of the comparison target file by using an index value representing a distance between character strings.
   6. The information processing apparatus according to supplementary note 5, wherein
the comparison unit corrects a degree of similarity between a name of the determination target file and a name of the comparison target file in such a way as to be greater than a value before correction when a first character is included in a name of the determination target file and a second character is included in a name of the comparison target file, and
the first character and the second character are predetermined characters different from each other.
   7. The information processing apparatus according to any one of supplementary notes 1 to 6, wherein,
when a control character is included in a name of the determination target file, the comparison unit compares a name of the determination target file being acquired by applying processing according to the control character with a name of the comparison target file.
   8. The information processing apparatus according to any one of supplementary notes 1 to 7, further including
a verification unit that determines whether an electronic signature is provided to the determination target file, and performs verification of the electronic signature when the electronic signature is provided to the determination target file, wherein
the comparison unit corrects a degree of reliability of the determination target file, based on a result of the verification.
   9. The information processing apparatus according to any one of supplementary notes 1 to 8, further including
an identification unit that identifies a presence number of files having a same name as that of the determination target file, wherein
the comparison unit corrects a degree of reliability of the determination target file in such a way as to be a greater value as the identified presence number is greater.
   10. An information processing apparatus, including:
a comparison unit that compares a name of a determination target file with a name of one or more comparison target files; and
an output unit that determines a display manner of information related to the determination target file, depending on whether a name of the determination target file coincides with a name of the comparison target file and according to similarity between a name of the determination target file and a name of the comparison target file, and outputs information related to the determination target file in the determined display manner.
   11. A control method being executed by a computer, including:
a comparison step of comparing a name of a determination target file with a name of one or more comparison target files; and
an output step of outputting information related to the determination target file, when a name of the determination target file does not coincide with a name of any of the comparison target files, and a degree of reliability of the determination target file is equal to or less than a threshold value, wherein
the comparison step includes calculating a degree of reliability of the determination target file, based on a degree of similarity between a name of the determination target file and a name of each of the comparison target files.
   12. The control method according to supplementary note 11, wherein
a name used for a comparison in the comparison step is any one or more of a file name, a path name, and a URL of a file.
   13. The control method according to supplementary note 11 or 12, wherein
the output step includes outputting information related to the determination target file in a more emphasized manner than another case when a name of the determination target file does not coincide with a name of the comparison target file, and a degree of reliability of the determination target file is equal to or less than a threshold value.
   14. The control method according to supplementary note 13, wherein
the output step includes performing different emphasizing on information related to the determination target file when a maximum value of a degree of similarity calculated between names of the determination target file and the comparison target file is equal to or less than a first threshold value and greater than a second threshold value, and when the maximum value is equal to or more than the second threshold value.
   15. The control method according to any one of supplementary notes 11 to 14, wherein
the comparison step includes calculating a degree of similarity between a name of the determination target file and a name of the comparison target file by using an index value representing a distance between character strings.
   16. The control method according to supplementary note 15, wherein
the comparison step includes correcting a degree of similarity between a name of the determination target file and a name of the comparison target file in such a way as to be greater than a value before correction when a first character is included in a name of the determination target file and a second character is included in a name of the comparison target file, and
the first character and the second character are predetermined characters different from each other.
   17. The control method according to any one of supplementary notes 11 to 16, wherein,
when a control character is included in a name of the determination target file, the comparison step includes comparing a name of the determination target file being acquired by applying processing according to the control character with a name of the comparison target file.
   18. The control method according to any one of supplementary notes 11 to 17, further including:

a verification step of determining whether an electronic signature is provided to the determination target file, and performing verification of the electronic signature when the electronic signature is provided to the determination target file, wherein
the comparison step includes correcting a degree of reliability of the determination target file, based on a result of the verification.
   19. The control method according to any one of supplementary notes 11 to 18, further including:

an identification step of identifying a presence number of files having a same name as that of the determination target file, wherein
the comparison step includes correcting a degree of reliability of the determination target file in such a way as to be a greater value as the identified presence number is greater.
   20. A control method being executed by a computer, including:
a comparison step of comparing a name of a determination target file with a name of one or more comparison target files; and
an output step of determining a display manner of information related to the determination target file, depending on whether a name of the determination target file coincides with a name of the comparison target file and according to similarity between a name of the determination target file and a name of the comparison target file, and outputting information related to the determination target file in the determined display manner.
   21. A program causing a computer to execute each step of the control method according to any one of supplementary notes 11 to 20.

What is claimed is:

1. An information processing apparatus, comprising:
a comparison unit that compares a name of a determination target file with a name of one or more comparison target files; and
an output unit that outputs information related to the determination target file, when a name of the determination target file does not coincide with a name of any of the comparison target files, and a degree of reliability of the determination target file is equal to or less than a threshold value, wherein
the comparison unit calculates a degree of reliability of the determination target file, based on a degree of similarity between a name of the determination target file and a name of each of the comparison target files.

2. The information processing apparatus according to claim 1, wherein
a name used for a comparison by the comparison unit is any one or more of a file name, a path name, and a URL of a file.

3. The information processing apparatus according to claim 1, wherein
the output unit outputs information related to the determination target file in a more emphasized manner than another case, when a name of the determination target file does not coincide with a name of the comparison target file, and a degree of reliability of the determination target file is equal to or less than a threshold value.

4. The information processing apparatus according to claim 3, wherein
the output unit performs different emphasizing on information related to the determination target file when a maximum value of a degree of similarity calculated between names of the determination target file and the comparison target file is equal to or less than a first threshold value and greater than a second threshold value, and when the maximum value is equal to or more than the second threshold value.

5. The information processing apparatus according to claim 1, wherein
the comparison unit calculates a degree of similarity between a name of the determination target file and a name of the comparison target file by using an index value representing a distance between character strings.

6. The information processing apparatus according to claim 5, wherein
the comparison unit corrects a degree of similarity between a name of the determination target file and a name of the comparison target file in such a way as to be greater than a value before correction when a first character is included in a name of the determination target file and a second character is included in a name of the comparison target file, and
the first character and the second character are predetermined characters different from each other.

7. The information processing apparatus according to claim 1, wherein,
when a control character is included in a name of the determination target file, the comparison unit compares a name of the determination target file being acquired by applying processing according to the control character with a name of the comparison target file.

8. The information processing apparatus according to claim 1, further comprising
a verification unit that determines whether an electronic signature is provided to the determination target file, and performs verification of the electronic signature when the electronic signature is provided to the determination target file, wherein
the comparison unit corrects a degree of reliability of the determination target file, based on a result of the verification.

9. The information processing apparatus according to claim 1, further comprising
an identification unit that identifies a presence number of files having a same name as that of the determination target file, wherein
the comparison unit corrects a degree of reliability of the determination target file in such a way as to be a greater value as the identified presence number is greater.

10. An information processing apparatus, comprising:
a comparison unit that compares a name of a determination target file with a name of one or more comparison target files; and
an output unit that determines a display manner of information related to the determination target file, depending on whether a name of the determination target file coincides with a name of the comparison target file and according to similarity between a name of the determination target file and a name of the comparison target file, and outputs information related to the determination target file in the determined display manner.

11. A control method being executed by a computer, comprising:
a comparison step of comparing a name of a determination target file with a name of one or more comparison target files; and
an output step of outputting information related to the determination target file, when a name of the determination target file does not coincide with a name of any of the comparison target files, and a degree of reliability of the determination target file is equal to or less than a threshold value, wherein
the comparison step includes calculating a degree of reliability of the determination target file, based on a degree of similarity between a name of the determination target file and a name of each of the comparison target files.

12. The control method according to claim 11, wherein
a name used for a comparison in the comparison step is any one or more of a file name, a path name, and a URL of a file.

13. The control method according to claim 11, wherein
the output step includes outputting information related to the determination target file in a more emphasized manner than another case, when a name of the determination target file does not coincide with a name of the comparison target file, and a degree of reliability of the determination target file is equal to or less than a threshold value.

14. The control method according to claim 13, wherein
the output step includes performing different emphasizing on information related to the determination target file when a maximum value of a degree of similarity calculated between names of the determination target file and the comparison target file is equal to or less than a first threshold value and greater than a second threshold value, and when the maximum value is equal to or more than the second threshold value.

15. The control method according to claim 11, wherein
the comparison step includes calculating a degree of similarity between a name of the determination target file and a name of the comparison target file by using an index value representing a distance between character strings.

16. The control method according to claim 15, wherein
the comparison step includes correcting a degree of similarity between a name of the determination target file and a name of the comparison target file in such a way as to be greater than a value before correction when a first character is included in a name of the determination target file and a second character is included in a name of the comparison target file, and
the first character and the second character are predetermined characters different from each other.

17. The control method according to claim 11, wherein,
when a control character is included in a name of the determination target file, the comparison step includes comparing a name of the determination target file being acquired by applying processing according to the control character with a name of the comparison target file.

18. The control method according to claim 11, further comprising:
a verification step of determining whether an electronic signature is provided to the determination target file, and performing verification of the electronic signature when the electronic signature is provided to the determination target file, wherein
the comparison step includes correcting a degree of reliability of the determination target file, based on a result of the verification.

19. The control method according to claim 11, further comprising:
an identification step of identifying a presence number of files having a same name as that of the determination target file, wherein
the comparison step includes correcting a degree of reliability of the determination target file in such a way as to be a greater value as the identified presence number is greater.

20. A control method being executed by a computer, comprising:
a comparison step of comparing a name of a determination target file with a name of one or more comparison target files; and
an output step of determining a display manner of information related to the determination target file, depending on whether a name of the determination target file coincides with a name of the comparison target file and according to similarity between a name of the determination target file and a name of the comparison target file, and outputting information related to the determination target file in the determined display manner.

21. A non-transitory computer readable medium having recorded thereon a program causing a computer to execute each step of the control method according to claim 11.

22. A non-transitory computer readable medium having recorded thereon a program causing a computer to execute each step of the control method according to claim 20.
